(19) United States
(12) Patent Application Publication
(10) Pub. No.: US 2022/0126882 A1
(43) Pub. Date: Apr. 28, 2022

(54) VEHICLE AND METHOD OF CONTROLLING AUTONOMOUS DRIVING OF VEHICLE

(71) Applicants: HYUNDAI MOTOR COMPANY, Seoul (KR); KIA CORPORATION, Seoul (KR)

(72) Inventor: Tae Dong Oh, Suwon-si (KR)

(21) Appl. No.: 17/382,880

(22) Filed: Jul. 22, 2021

(30) Foreign Application Priority Data
Oct. 28, 2020 (KR) 10-2020-0141304

(51) Int. Cl. B60W 60/00; B60W 30/095; B60W 30/18; B60W 40/04; B60W 40/105

(52) U.S. Cl. CPC B60W 60/00274; B60W 30/0956; B60W 30/18163; B60W 2554/80; B60W 40/105; B60W 2554/4045; B60W 2554/4041; B60W 40/04

(57) ABSTRACT

A method of controlling autonomous driving includes: collecting driving information of a subject vehicle that autonomously drives and driving information of at least one vehicle among other vehicles around the subject vehicle, determining driving intention of the at least one vehicle based on the driving information of the at least one vehicle, predicting a driving path of the at least one vehicle based on the driving information of the at least one vehicle, determining a target lane of the subject vehicle based on a driving path of the at least one vehicle, and determining a driving path of the subject vehicle based on the target lane of the subject vehicle and the driving path of the at least one vehicle.

### CROSS-REFERENCE TO RELATED APPLICATION

The present application claims the benefit of priority to Korean Patent Application No. 10-2020-0141304, filed on Oct. 28, 2020 in the Korean Intellectual Property Office, which is hereby incorporated by reference as if fully set forth herein.

### TECHNICAL FIELD

The present disclosure relates to an autonomous driving control apparatus and method for maintaining a smooth driving state in consideration of driving intention of another vehicle during autonomous driving.

### BACKGROUND

In general, an autonomous vehicle refers to a vehicle that is capable of driving to a destination by autonomously recognizing a road and surroundings without driver manipulation of an accelerator pedal, a steering wheel, a brake pedal, or the like.

A conventional autonomous vehicle outputs a driving path of another vehicle by calculating a predicted path of the corresponding vehicle using the position and dynamics information of the other vehicle and matching the calculation result with a detailed map.

However, vehicles that drive on an actual road need to change the driving path depending on the driving state and driving intention of a nearby vehicle, the current signal of a traffic light, and the like, and accordingly, the driving path predicted using only the position and the dynamics information and an actual driving path of another vehicle may be different from each other. Thus, on a road with many vehicles or on a complex road, there is a problem in that it is difficult to maintain an autonomous driving state because false warnings and non-warnings frequently occur during autonomous driving according to the conventionally predicted path.

The information included in this Background section is only for enhancement of understanding of the general background of the present disclosure and may not be taken as an acknowledgement or any form of suggestion that this information forms the prior art already known to a person skilled in the art.

### SUMMARY

The present disclosure is directed to an autonomous driving control apparatus and method for maintaining an optimum driving state by determining a path to be selected for smooth driving of a subject vehicle in consideration of driving intention of other vehicles.

In particular, the present disclosure provides an autonomous driving control apparatus and method for maintaining an optimum driving state by predicting paths of other vehicles present in a search area in consideration of the distance between nearby vehicles, driving intention of a nearby vehicle, speed, whether a dangerous vehicle is present, and surrounding infrastructure and determining a driving path of the subject vehicle based on the predicted paths of the other vehicles.

The technical problems solved by the embodiments are not limited to the above technical problems and other technical problems which are not described herein will become apparent to those skilled in the art from the following description.

To achieve these objects and other advantages and in accordance with the purpose of the disclosure, as embodied and broadly described herein, a method of controlling autonomous driving includes collecting driving information of a subject vehicle that autonomously drives and driving information of at least one vehicle among other vehicles around the subject vehicle, determining driving intention of the at least one vehicle based on the driving information of the at least one vehicle, predicting a first driving path of the at least one vehicle based on the driving information of the at least one vehicle, determining a target lane of the subject vehicle based on the first driving, and determining a second driving path of the subject vehicle based on the target lane of the subject vehicle and the first driving path.

In another aspect of the present disclosure, an apparatus for controlling autonomous driving includes: a first determiner configured to collect driving information of a subject vehicle that autonomously drives and driving information of at least one vehicle among other vehicles around the subject vehicle and to determine a driving environment, a second determiner configured to determine driving intention of the at least one vehicle based on the driving information of the another vehicle, and a driving controller configured to predict a first driving path of the at least one vehicle based on driving intention of the at least one vehicle and the driving information of the another vehicle and to determine a second driving path of the subject vehicle based on the first driving path.

### BRIEF DESCRIPTION OF THE DRAWINGS

The accompanying drawings, which are included to provide a further understanding of the disclosure and are incorporated in and constitute a part of the present application, illustrate embodiment(s) of the disclosure and together with the description serve to explain the principle of the disclosure.

FIG. 1 is a schematic block diagram of an autonomous driving control apparatus according to an embodiment of the present disclosure;

FIG. 2 is a block diagram showing an example of the configuration of an other-vehicle determiner of FIG. 1;

FIG. 3 is a block diagram showing an example of the configuration of a driving controller of FIG. 1;

FIG. 4 is a schematic flowchart of a method of controlling autonomous driving according to an embodiment of the present disclosure;

FIG. 5 is a control flowchart of an other-vehicle determiner according to an embodiment of the present disclosure;

FIG. 6 is a control flowchart of a driving controller according to an embodiment of the present disclosure;

FIG. 7 is a diagram for explaining a method of determining a driving strategy of a subject vehicle according to an embodiment of the present disclosure;

FIGS. 8 and 9 is a diagram for explaining a method of predicting a path based on driving intention of another vehicle according to an embodiment of the present disclosure;

FIG. 10 is a diagram for explaining a method of determining a target lane of a subject vehicle according to an embodiment of the present disclosure;

FIGS. 11 to 15 are diagrams for explaining a method of scheduling a driving strategy of a subject vehicle according to an embodiment of the present disclosure;

FIGS. 16 and 17 are diagrams for explaining a method of changing a strategy of a subject vehicle according to an embodiment of the present disclosure; and

FIGS. 18 and 19 are diagrams for explaining a method of controlling a subject vehicle based on driving intention of another vehicle according to an embodiment of the present disclosure.

### DETAILED DESCRIPTION

Hereinafter, the embodiments of the present disclosure will be described in detail with reference to the accompanying drawings so as to be easily implemented by those skilled in the art. However, the present disclosure may be variously implemented, and is not limited to the embodiments described herein. In the drawings, in order to clearly describe the present disclosure, portions which are not related to the description of the present disclosure will be omitted, and similar portions are denoted by similar reference numerals throughout the specification.

Throughout the specification, when a certain portion is said to “include” a certain component, this does not indicate that other components are excluded, and the same may be further included unless specifically described to the contrary. The same reference numbers will be used throughout the drawings to refer to the same or like parts.

An autonomous driving control apparatus according to the present disclosure may analyze the tendency of another vehicle to determine a driving strategy in consideration of the distance between nearby vehicles, driving intention of a nearby vehicle, speed, whether a dangerous vehicle is present, and surrounding infrastructure and may predict driving strategies for all vehicles in a predetermined search area based on the analysis result. Based on the predicted driving strategy of another vehicle, the autonomous driving control apparatus may control driving by determining a path to be selected for smooth driving of a subject vehicle and selecting a driving strategy for entrance into a corresponding path when controlling driving of the subject vehicle. As such, a reference for determining risk may be variably applied in consideration of driving intention of another vehicle by controlling autonomous driving in consideration of the driving intention of the other vehicle, and accordingly, false warnings and non-warnings may be reduced, and unnecessary stoppage or deceleration of the subject vehicle, which occur when a future position of the other vehicle is not considered, may be reduced. In addition, even in various driving environments including a complex driving situation such as a situation in which the subject vehicle responds to a preceding vehicle that changes lanes or a situation in which two or more vehicles simultaneously change lanes, it may be possible to optimally control driving of the subject vehicle based on driving intention of other vehicles.

Hereinafter, an apparatus for controlling driving of a vehicle according to an embodiment of the present disclosure will be described with reference to the drawings. First, main terms used in the specification and the drawings will be described.

Subject vehicle: My own vehicle

Another vehicle, other vehicles: A vehicle except for the subject vehicle

Nearby vehicle: A vehicle except for the subject vehicle, detected by a sensor installed in the subject vehicle

Preceding vehicle: A nearby vehicle driving right in front of the subject vehicle

Driving lane: A lane in which the subject vehicle currently drives

Target lane: A lane to which the subject vehicle intends to move

Target lane vehicle: A nearby vehicle driving in the target lane

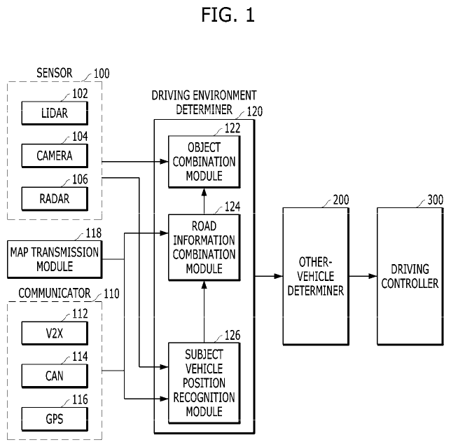

FIG. 1 is a schematic block diagram of an autonomous driving control apparatus according to an embodiment of the present disclosure.

Referring to FIG. 1, the driving control apparatus according to an embodiment of the present disclosure may include a sensor 100, a communicator 110, a map transmission module 118, a driving environment determiner 120, an other-vehicle determiner 200, and a driving controller 300.

The sensor 100 may sense at least one nearby vehicle positioned at front, lateral, and rear sides of the subject vehicle and may detect a position, a speed, and an acceleration of each nearby vehicle. The sensor 100 may include various sensors installed at the front, lateral, and rear sides of the subject vehicle, including a LiDAR 102, a camera 104, and a radar 106.

The LiDAR 102 may measure a distance between the subject vehicle and the nearby vehicle. The LiDAR 102 may calculate spatial location coordinates of a reflection point by measuring a time of arrival of a laser pulse reflected from the nearby vehicle and may check the distance to the nearby vehicle, the shape of the nearby vehicle, and so on.

The camera 104 may acquire an image of a region around the subject vehicle through an image sensor. The camera 104 may include an image processor for performing image processing, such as noise removal, image quality and saturation adjustment, and file compression, on the acquired image.

The radar 106 may measure the distance between the subject vehicle and the nearby vehicle. The radar 106 may check information including the distance, direction, and elevation with respect to the nearby vehicle by emitting an electromagnetic wave towards the nearby vehicle and receiving the electromagnetic wave reflected from the nearby vehicle.

The communicator 110 may receive plural pieces of information for detecting the positions of the subject vehicle and other vehicles. The communicator 110 may include various devices for receiving plural pieces of information for recognizing the position of the subject vehicle, including a vehicle to everything (V2X) 112, a controller area network (CAN) 114, and a global positioning system (GPS) 116.

The map transmission module 118 may provide a detailed map for differentiating between lanes. The detailed map may be stored in the form of a database (DB), may be automatically updated at regular intervals using wireless communication or manually updated by a user, and may include information on a merge section for each lane (e.g., information on the position of the merge section and information on a speed limit of each merge section), information on a road for each position, information on an off-ramp, and information on an intersection.

The driving environment determiner 120 may combine object information of the subject vehicle and other vehicles with the detailed map based on the information acquired through the sensor 100, the map transmission module 118, and the communicator 110 and may output the result. The driving environment determiner 120 may include an object combination module 122, a road information combination module 124, and a subject vehicle position recognition module 126.

The subject vehicle position recognition module 126 may output detailed position information of the subject vehicle. The subject vehicle position recognition module 126 may compare information sensed by the sensor 100 with GPS information of the subject vehicle, collected through the communicator 110, and detailed map information provided by the map transmission module 118 and may output position information and position recognition reliability information of the subject vehicle together.

The road information combination module 124 may output a detailed map of a region around the subject vehicle. The road information combination module 124 may output information on a detailed map of a region around the subject vehicle to the object combination module 122 using position recognition information and detailed map information.

The object combination module 122 may output combination object information to the deflection path generator 200. The object combination module 122 may combine an object with the detailed map using the information sensed by the sensor 100 and the information on the detailed map of the region around the subject vehicle and may output the result.

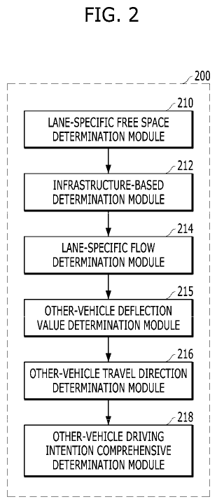

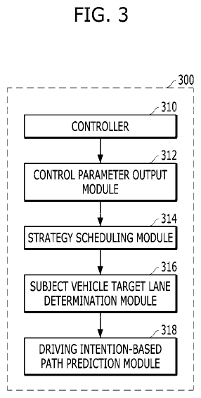

The other-vehicle determiner 200 may receive information obtained by combining an object with a detailed map and may determine driving intention of the other vehicle, and the driving controller 300 may determine a driving path of the subject vehicle based on the driving disclosure of the other vehicle output from the other-vehicle determiner 200 and may control a driving state. The other-vehicle determiner 200 and the driving controller 300 may be configured as shown in the block diagrams of FIGS. 2 and 3.

FIG. 2 is a block diagram showing an example of the configuration of the other-vehicle determiner 200 of FIG. 1.

The other-vehicle determiner 200 may receive information obtained by combining an object with a detailed map output from the driving environment determiner 120 and may determine driving intention of another vehicle.

Referring to FIG. 2, the other-vehicle determiner 200 may include a lane-specific free space determination module 210, an infrastructure-based determination module 212, a lane-specific flow determination module 214, an other-vehicle deflection value determination module 215, an other-vehicle travel direction determination module 216, and an other-vehicle driving intention comprehensive determination module 218.

The lane-specific free space determination module 210 may output a distance point between vehicles based on the distance between vehicles.

The infrastructure-based determination module 212 may determine and output travel points of vehicles based on the current signal, the remaining time and a next signal (when it is possible to use V2X), a bus stop/school zone road mark, and the like.

The lane-specific flow determination module 214 may calculate and output a flow rate in a corresponding lane as a point based on a speed of a vehicle.

The other-vehicle deflection value determination module 215 may output a degree by which another vehicle drives to be deflected, as a point, based on the center of a lane in which the other vehicle drives.

The other-vehicle travel direction determination module 216 may output an angle at which the other vehicle travels, as a point, based on a target lane of the other vehicle.

The other-vehicle driving intention comprehensive determination module 218 may finally output a target lane in which the other vehicle drives in comprehensive consideration of the points of the aforementioned five sub modules.

FIG. 3 is a block diagram showing an example of the configuration of the driving controller 300 of FIG. 1.

The driving controller 300 may control autonomous driving of the subject vehicle based on a target lane of another vehicle, that is, driving intention of the other vehicle determined by the other-vehicle determiner 200.

Referring to FIG. 3, the driving controller 300 may include a driving intention-based path prediction module 318, a subject vehicle target lane determination module 316, a strategy scheduling module 314, a control parameter output module 312, and a controller 310.

The driving intention-based path prediction module 318 may output a predicted path of the other vehicle based on driving intention and dynamics of the other vehicle, and detailed map matching information.

The subject vehicle target lane determination module 316 may output a target lane of the subject vehicle in consideration of the target lane and the current dynamic characteristics of nearby vehicles of the subject vehicle.

The strategy scheduling module 314 may plan a detailed control path based on positions of the subject vehicle and the other vehicle, predicted for each future frame, dynamics information, detailed map information, and driving intention in order to dynamically plan a path for moving along the target lane of the subject vehicle.

The control parameter output module 312 may output a control parameter through a control path and a speed profile of the subject vehicle, which are derived through strategy scheduling.

The controller 310 may control autonomous driving of a vehicle according to a control parameter.

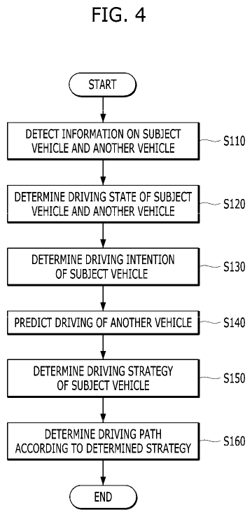

FIG. 4 is a schematic flowchart of a method of controlling autonomous driving according to an embodiment of the present disclosure.

Driving information of the subject vehicle and the other vehicle may be acquired using information of the subject vehicle and the other vehicle and detailed map information, which are acquired through the sensor 100 and the communicator 110 (S110).

A driving environment of the subject vehicle and the other vehicle may be determined based on the acquired information (S120). The object combination module 122 of the driving environment determiner 120 may combine an object with the detailed map and may output the combined information through the acquired information and detailed map information.

The driving environment of the subject vehicle and the other vehicle may be analyzed and the driving intention of the other vehicle may be determined (S130). The target lane in which the other vehicle drives may be determined in comprehensive consideration of a lane-specific free space of the other vehicle, a signal state, a lane-specific traffic flow, a deflection value and a travel direction of the other vehicle, and so on.

The driving path of the other vehicle may be predicted based on the target lane and dynamics of the other vehicle and the detailed map matching information (S140).

A driving strategy of the subject vehicle may be determined based on positions of the subject vehicle and the other vehicle, predicted for each future frame, dynamics information, detailed map information, and driving intention in order to dynamically plan a path for moving along the target lane of the subject vehicle (S150).

Driving may be controlled according to the determined driving strategy (S160).

As described above, according to the present disclosure, in consideration of an interaction with nearby vehicles, driving may be controlled by determining a path to be selected for smooth driving of a subject vehicle and selecting a driving strategy for entrance into a corresponding path when controlling driving of the subject vehicle. Accordingly, driving may be smoothly controlled by predicting driving paths of other vehicles in advance in various driving environments including a complex driving situation such as a situation in which preceding vehicles simultaneously change lanes.

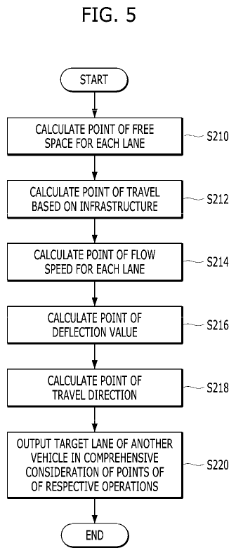

FIG. 5 is a control flowchart of the other-vehicle determiner 200 according to an embodiment of the present disclosure.

The other-vehicle determiner 200 may receive information obtained by combining an object with a detailed map output from the driving environment determiner 120 and may determine driving intention of another vehicle.

To this end, the other-vehicle determiner 200 may output a distance point between vehicles based on the distance between vehicles (S210).

Travel points of vehicles may be determined and output based on the current signal, the remaining time and a next signal (when it is possible to use V2X), a bus stop/school zone road mark, and the like (S212).

A flow rate in a corresponding lane may be calculated and output as a point based on speed of vehicles driving in respective lanes (S214).

A degree by which another vehicle drives to be deflected may be output as a point based on the center of a lane in which the other vehicle drives (S216).

An angle at which the other vehicle travels may be output as a point based on a target lane of the other vehicle (S218).

A target lane in which the other vehicle drives may be finally output in comprehensive consideration of the points calculated in the respective operations (S220).

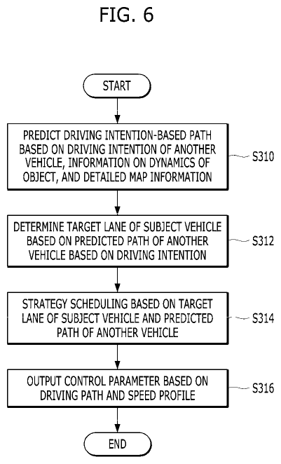

FIG. 6 is a control flowchart of the driving controller 300 according to an embodiment of the present disclosure.

The driving controller 300 may control autonomous driving of the subject vehicle based on a target lane of another vehicle, that is, driving intention of the other vehicle determined by the other-vehicle determiner 200.

To this end, the driving controller 300 may predict a path of the other vehicle based on driving intention and dynamics of the other vehicle, and detailed map matching information (S310).

The target lane of the subject vehicle may be determined in consideration of the target lane and the current dynamic characteristics of nearby vehicles of the subject vehicle (S312).

The control path may be scheduled based on the target lane of the subject vehicle and the predicted path of the other vehicle (S314). The driving controller 300 may plan a detailed control path based on positions of the subject vehicle and the other vehicle, predicted for each future frame, dynamics information, detailed map information, and driving intention.

Then, a control parameter may be output based on the determined driving path and speed profile (S316).

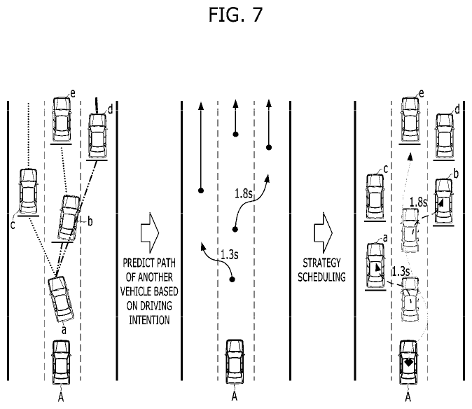

FIG. 7 is a diagram for explaining a method of determining a driving strategy of a subject vehicle according to an embodiment of the present disclosure.

Referring to the left figure of FIG. 7, a subject vehicle A may predict a path based on driving intention of another vehicle through target lanes, times taken to change lanes, current travel directions, speeds, and deflection values of other vehicles a, b, c, d, and e using the other-vehicle determiner 200.

Referring to the middle figure of FIG. 7, the path of the other vehicle predicted by the other-vehicle determiner 200 may be derived as a set of location coordinates for T seconds. When the predicted path of the other vehicle is represented as location coordinates for each time, the path may be indicated by an arrow formed by connecting coordinates of a start point to coordinates of a location after T seconds. In the middle figure of FIG. 7, the other vehicle a may be predicted to move to a left lane over 1.3 seconds, and the other vehicle b may be predicted to move to a right lane over 1.8 seconds.

Referring to the right figure of FIG. 7, the driving controller 300 may predict that the other vehicle a and the other vehicle b deviate from the current driving lane of the subject vehicle A and may determine a path along which the subject vehicle A is maintained in the current lane.

When paths of other vehicles are not considered, more vehicles may drive in the current driving lane of the subject vehicle A than in other lanes in a driving environment shown in FIG. 7, and the subject vehicle A may be determined to change lanes to a lane with few vehicles and to drive therein. However, according to the present disclosure, the other vehicle a and the other vehicle b, each of which is a preceding vehicle of the subject vehicle A, may be predicted to change lanes, and a path along which the subject vehicle A is maintained in the current lane may be determined.

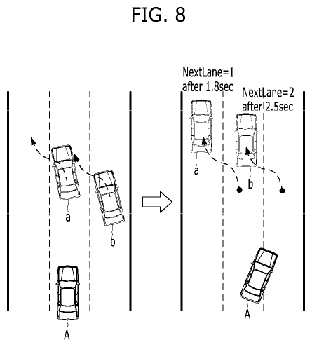

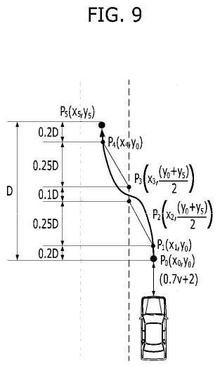

FIGS. 8 and 9 are diagrams for explaining a method of predicting a path based on driving intention of another vehicle according to an embodiment of the present disclosure. FIG. 8 is a diagram showing an example in which a path is generated based on driving vehicle of another vehicle. FIG. 9 is a diagram showing an example of a method of generating a predicted path of another vehicle.

Referring to FIG. 8, the subject vehicle A may predict a path based on driving intention of another vehicle through target lanes, times taken to change lanes, current travel directions, speeds, and deflection values of the other vehicles a and b using the other-vehicle determiner 200. The predicted path values may be derived as a set of location coordinates for T seconds. In the embodiment of FIG. 8, the other vehicle a may be predicted to move to a left lane over 1.8 sec, and the other vehicle b may be predicted to move a right lane over 2.5 sec. The subject vehicle needs to determine a longitudinal/traverse driving strategy in comprehensive consideration of a set of location coordinates (predicted path) for T seconds of nearby vehicles, and accordingly, to this end, paths of other vehicles need to be predicted.

FIG. 9 is a diagram showing an example of a method of generating a predicted path of another vehicle and illustrates an example of a path along which a vehicle changes lanes in a symmetric form using a start point (the current position of another vehicle) and an end point (the position of another vehicle on a target lane line after T seconds) as control points that are relatively appropriate to lane change based on 5^{th} Bezier curve. However, a method of generating a predicted path of another vehicle may not be limited to a specific method and may include various methods.

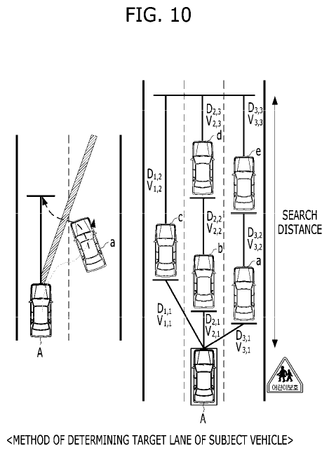

FIG. 10 is a diagram for explaining a method of determining a target lane of a subject vehicle according to an embodiment of the present disclosure.

According to an embodiment of the present disclosure, from the subject vehicle point of view, a target lane that is recommended in advance may also be determined based on a similar logic to predicted driving of another vehicle. When the target lane of the subject vehicle is determined, this may not be dependent upon only the currently observed deflection value and travel direction and dynamics information, and the lane may be dynamically planned in consideration of a situation of a nearby vehicle and the subject vehicle may drive in the lane.

When the target lane of the subject vehicle is determined, a lane with the greatest driving advantage may be selected in consideration of a surrounding situation, and a selection method thereof may be represented using the following equation.

D_{(LaneNum),N}: Distance point between following point of N^{th} vehicle and (N−1)^{th} vehicle in (LaneNum)^{th} lane

V_{(LaneNum),N}: Traffic flow point between following point of N^{th} vehicle and (N−1)^{th} vehicle in (LaneNum)^{th} lane

I_{(LaneNum)}: travel point based on infrastructure of subject vehicle in (LaneNum)^{th} lane

w_{D}, w_{V}, w_{I}: Weight of each of distance point, traffic flow point, and infrastructure point

$${S}_{LaneNum , Total} = ( {\sum }_{N} {D}_{LaneNum , N} ) * {w}_{D} + ( {\sum }_{N} {V}_{LaneNum , N} ) * {w}_{V + {I}_{LaneNum}} * {w}_{l}$$

$$NextLaneNum = {arg max}_{LaneNum} ( {S}_{LaneNum , Total} )$$

NextLaneNum calculated using the above equation may be assigned to a prior-order target lane of the subject vehicle. However, when it is impossible to enter a corresponding lane as a result of determination of risk, longitudinal control (acceleration/deceleration) may be performed while the current lane is maintained.

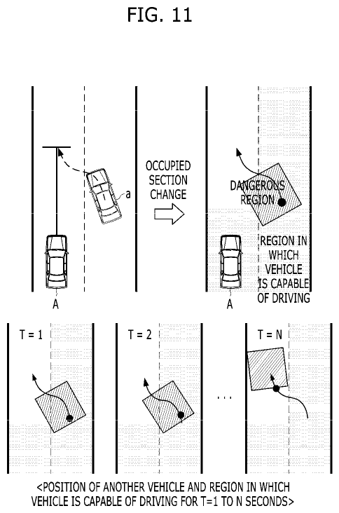

FIGS. 11 to 15 are diagrams for explaining a method of scheduling a driving strategy of a subject vehicle according to an embodiment of the present disclosure. Strategy scheduling may be defined as dynamic path planning of the subject vehicle in consideration of a set of situations predicted in respective future frames. When a path of the subject vehicle is planned, it may be required to dynamically plan the path of the subject vehicle to ensure that the subject vehicle and nearby vehicles do not overlap in consideration of occupied sections of the subject vehicle and the nearby vehicles for each future frame.

Referring to FIG. 11, a region in which a vehicle is capable of traveling may be determined depending on the dynamic characteristics and driving intention of the nearby vehicle a (e.g., lane change, lane keeping, and acceleration and deceleration) for each future frame as well as the current time point.

A set of information on the position, speed (differential value of position of predicted path), occupied section (=dangerous region), a region in which a vehicle is capable of driving, a travel direction, a deflection value, and a target lane of the nearby vehicle a in each discretized frame, which corresponds to the reliable prediction maximum time (T=N seconds) from the current time (T=1) may be used in strategy scheduling of the subject vehicle. In this case, a path of the subject vehicle A may be dynamically planned in consideration of a set of situations predicted for respective future frames rather than being statically planned in consideration of only the current time and situation. In addition, as necessary, the region in which a vehicle is capable of driving may be reversely calculated from information on the size and predicted path of the other vehicle a, and accordingly, may be a factor to be replaced with the predicted path.

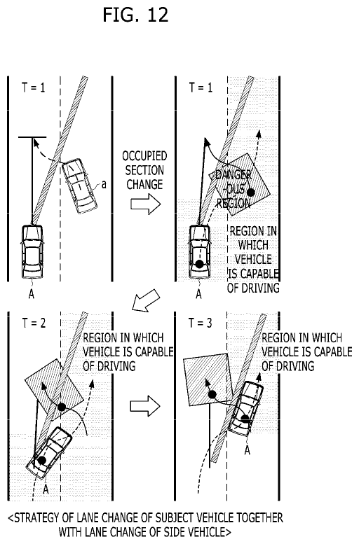

FIG. 12 is a diagram showing an example of the case in which the subject vehicle A leads to smoother driving through change in driving lanes in response to blocking of a path of the subject vehicle A due to lane change of the other vehicle a through strategy scheduling.

For example, when driving intention of the other vehicle a corresponds to lane change and the current dynamic characteristics correspond to the current lane change to a target lane, a predicted path for lane change to the target lane from the current driving lane may be formed. Accordingly, a region except for a predicted position of a vehicle and an occupied section of the vehicle in each frame may be a region in which the subject vehicle A is capable of driving in a corresponding frame.

In another example, when driving intention of the other vehicle a corresponds to deceleration while lane keeping and the current dynamic characteristics correspond to deceleration in a driving lane, a predicted deceleration path for preventing collision with a nearby vehicle in the current driving lane may be formed. Accordingly, a region except for a predicted position of a vehicle and an occupied section of the vehicle in each frame may be a region in which the subject vehicle A is capable of driving in a corresponding frame.

The subject vehicle A may have a degree of freedom corresponding to a range of a physically moveable distance from a previous position within the region in which the vehicle is capable of driving. Thus, the suitability of the path may be determined by establishing a strategy of lane change of the subject vehicle A and then verifying the predicted path of the other vehicle a and the possibility of collision in each time frame.

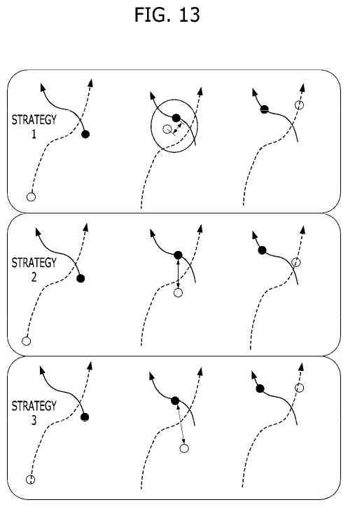

FIG. 13 is a diagram showing an example of a method of generating a strategy for changing a path of a subject vehicle.

When the strategy for changing a path is generated, it may be required to dynamically plan the path of the subject vehicle to ensure that the subject vehicle A and the nearby vehicle a do not overlap in consideration of occupied sections of the subject vehicle A and the nearby vehicle a for each future frame.

As shown in FIG. 13, among three strategies, the case in which the above condition is not satisfied may be Strategy 1. This is because, when a vehicle travels according to Strategy 1, there is a frame in which the subject vehicle A is close to the other vehicle a enough to collide with each other. However, there may be numerous available strategies other than Strategy 1. A position in a next frame may be determined under a constraint in which a distance between the subject vehicle A and the other vehicle a is not equal to or less than a threshold point in each frame, the subject vehicle A is capable of physically moving in consideration of the current dynamic characteristics of the subject vehicle A, and the subject vehicle A approaches the target lane of the subject vehicle A. A set of strategies determined in the above method may be a ‘candidate strategy’, numerous strategies may be present, and representative strategies may be selected in consideration of computational load. For example, N representative strategies that satisfy the constraint may be generated while control points constituting a path are moved to the minimum resolution.

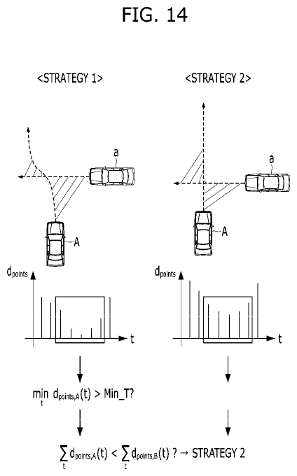

FIG. 14 is a diagram for explaining a method of determining the most preferred strategy among N strategies. For control of driving, the most preferred strategy may be determined among the N generated strategies. FIG. 14 illustrates an example of the strategy determination method when a preference reference is focused on “safety of subject vehicle while driving” and a constraint is set to the case in which “the distance between the subject vehicle and another vehicle is equal to or greater than a threshold value and the sum of distances is the maximum”. The preference reference may also be changed to or complemented by another method for ensuring driving stability, ride comfort, and smooth driving.

When the preference reference is selected as “safety of subject vehicle while driving”, the path may be predicted to satisfy a condition in which “the distance between the subject vehicle and another vehicle is equal to or greater than a threshold point and the sum of distances is the maximum”.

The pre-calculated predicted path of the other vehicle a and the predicted path of the subject vehicle A are contained in position information of an object for each time, and thus a predicted relative distance dpoints(t) between objects may be calculated for each time.

When the distance dpoints(t) between the subject vehicle A and the other vehicle a at time t is small enough to be close to actual collision (<Min_T(Min_T: the minimum time for response of the subject vehicle with respect to collision)), the corresponding path may cause high risk, and thus may be excluded from a candidate.

When an interval between the subject vehicle A and the other vehicle a for each time is continuously increased, the corresponding path may be determined to be a safer path. Here, as the accuracy of predicted paths is increased, the possibility of collision may be more accurately determined.

In order to determine a safe path and a dangerous path, a strategy in which an interval between two objects is comprehensively determined to be great may be selected using a meaningful statistical method including the sum of relative distances dpoints(t) for each time, an average time, the minimum value, and a median.

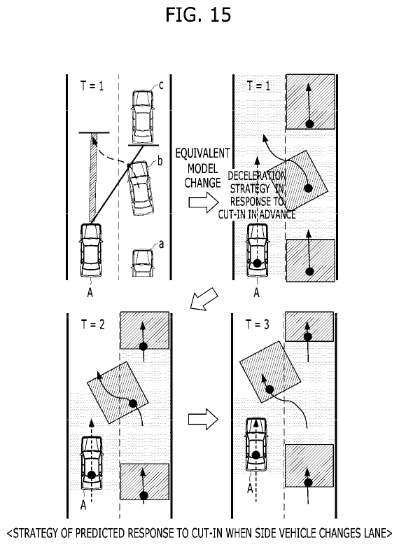

FIG. 15 is a diagram showing a method of predicting and responding to cut-in of the other vehicle b through strategy scheduling.

When a path of the subject vehicle A is blocked and lane change of the subject vehicle A is also blocked due to lane change of the other vehicle b, strategy scheduling may be performed by predicting cut-in of the other vehicle b and responding to cut-in of the other vehicle b through deceleration of the subject vehicle A in advance. Sudden cut-in of a taxi, a bus, or the like may also be predicted and may be rapidly and safely responded to using a method of predicting and responding to cut-in in advance.

A subject vehicle may travel along an appropriate path in response to change even in a situation of change in intention of a nearby vehicle, late recognition of an unrecognized object, or false recognition by recalculating such strategy scheduling for each frame.

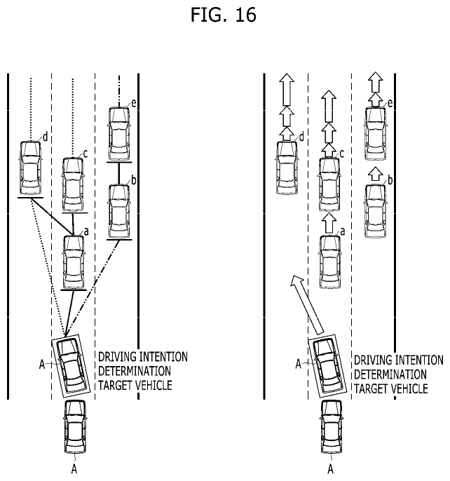

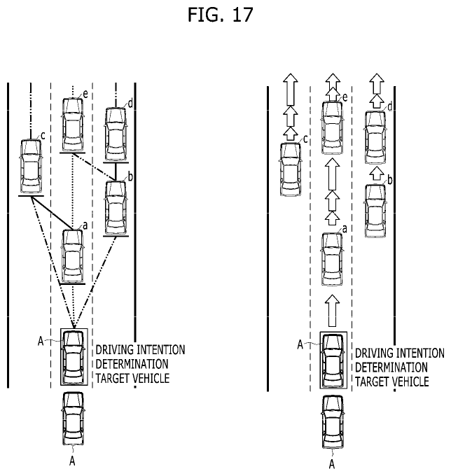

FIGS. 16 and 17 are diagrams for explaining a method of changing a strategy of a subject vehicle according to an embodiment of the present disclosure. FIG. 16 illustrating an example of a driving control method of a subject vehicle with respect to change to a left lane of a preceding vehicle. FIG. 17 illustrates an example of a driving control method of a subject vehicle with respect to lane keeping of a preceding vehicle.

Referring to FIG. 16, a vehicle f driving right in front of the subject vehicle A may be a determination target vehicle of driving intention. When it is determined that the distance between vehicles in a left lane is wide, a traffic flow is smooth, and the vehicle f as the determination target vehicle of driving intention moves towards a left side, the corresponding vehicle f may be predicted to be changed to the left lane.

Accordingly, the subject vehicle A may be controlled to be maintained in the current lane or to be changed to a right lane.

Referring to FIG. 17, the vehicle f driving right in front of the subject vehicle A may be a determination target vehicle of driving intention. When it is determined that the distance between vehicles in a lane in which the subject vehicle A drives is average, a traffic flow is smooth, and the vehicle f as the determination target vehicle of driving intention behaves in a general driving state, the corresponding vehicle f may be predicted to be maintained in the current lane.

Accordingly, the subject vehicle A may be controlled to be maintained in the current lane or to change from the current lane to a left lane in which the distance between vehicles is wide.

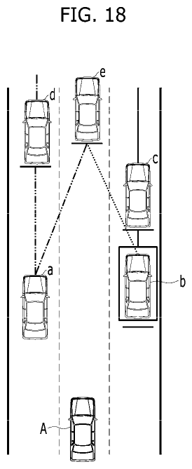

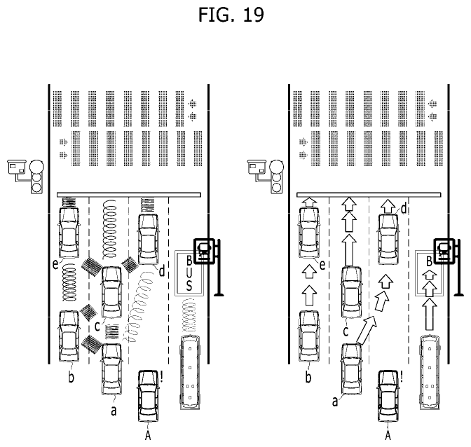

FIGS. 18 and 19 are diagrams for explaining a method of controlling a subject vehicle based on driving intention of another vehicle according to an embodiment of the present disclosure.

FIG. 18 is a diagram for explaining a method of reducing the possibility of false warnings or non-warnings by changing and applying the sensitivity of response when cut-in of a right vehicle is predicted.

A vehicle having high possibility of cut-in may be determined based on driving states of vehicles a, b, c, d, and e that travel in front of the subject vehicle A.

The vehicle b is very close to the vehicle that is a preceding vehicle in the same lane, and thus the possibility of cut-in of the vehicle b may be determined to be high. Thus, the sensitivity of response to cut-in of the vehicle b may be set to be high, and accordingly the possibility of non-warnings may be reduced.

The vehicle c has high possibility of straight driving, and thus the sensitivity of response to cut-in may be set to be low. Accordingly, the possibility of false warnings may be reduced.

A general cut-in reference may be applied to the vehicle a, and a strict cut-in reference may be applied to the vehicle d.

FIG. 19 is a diagram for explaining a method of controlling driving by determining driving intention of another vehicle in a complex road situation.

When a stop sign is present ahead and a vehicle needs to stop after being decelerated, cut-in of the vehicle a in a left lane of the subject vehicle A may be predicted. Because a right lane of the subject vehicle A is a bus lane, the subject vehicle A is not capable of changing lanes to the right lane, and thus the subject vehicle A needs to be maintained in the current lane. Accordingly, driving of the subject vehicle A may be controlled by scheduling a strategy of decelerating the subject vehicle A in advance in response to cut-in of the vehicle a in the left lane or accelerating the subject vehicle A to previously enter a target lane prior to cut-in.

As described above, according to the present disclosure, an optimum driving state may be maintained in various driving environments including a complex driving situation such as a situation in which the subject vehicle responds to a preceding vehicle that changes lanes or a situation in which two or more vehicles simultaneously change lanes by predicting paths of other vehicles present in a search area in consideration of the distance between nearby vehicles, driving intention of a nearby vehicle, speed, whether a dangerous vehicle is present, and surrounding infrastructure and determining a driving path of the subject vehicle based on the predicted paths of the other vehicles.

The autonomous driving control apparatus and method related to at least one embodiment of the present disclosure as configured above may maintain an optimum driving state by determining a path to be selected for smooth driving of a subject vehicle in consideration of driving intention of other vehicles.

In particular, an optimum driving state may be maintained in various driving environments including a complex driving situation such as a situation in which the subject vehicle responds to a preceding vehicle that changes lanes or a situation in which two or more vehicles simultaneously change lanes by predicting paths of other vehicles present in a search area in consideration of the distance between nearby vehicles, driving intention of a nearby vehicle, speed, whether a dangerous vehicle is present, and surrounding infrastructure and determining a driving path of the subject vehicle based on the predicted paths of the other vehicles.

A reference for determining risk may be variably applied in consideration of driving intention of another vehicle, and accordingly, false warnings and non-warnings may be reduced, and unnecessary stoppage or deceleration of the subject vehicle, which occur when a future position of the other vehicle is not considered, may be reduced.

It will be appreciated by persons skilled in the art that that the effects that could be achieved with the present disclosure are not limited to what has been particularly described hereinabove and other advantages of the present disclosure will be more clearly understood from the detailed description.

The disclosure can also be embodied as computer readable code on a computer readable recording medium. The computer readable recording medium is any data storage device that can store data which can thereafter be read by a computer system. Examples of the computer readable recording medium include hard disk drive (HDD) , solid state disk (SSD) , silicon disk drive (SDD), read-only memory (ROM), random-access memory (RAM), CD-ROMs, magnetic tapes, floppy disks, and optical data storage devices.

The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

What is claimed is:

1. A method of controlling autonomous driving, the method, which is performed by a controller, comprising:
collecting driving information of a subject vehicle that autonomously drives and driving information of at least one vehicle among other vehicles around the subject vehicle;
determining driving intention of the at least one vehicle based on the driving information of the at least vehicle;
predicting a first driving path of the at least one vehicle based on the driving information of the at least one vehicle;
determining a target lane of the subject vehicle based on the first driving path of the at least one vehicle;
determining a second driving path of the subject vehicle based on the target lane of the subject vehicle and the first driving path of the at least one vehicle; and
controlling the subject vehicle to move along the second driving path away from the first driving path.

2. The method of claim 1, wherein the driving information includes at least one of information on positions of the subject vehicle and the at least one vehicle, speed information, acceleration information, detailed map information, or infrastructure information including a traffic light, a bus stop, and a school zone.

3. The method of claim 1, wherein the determining the driving information of the at least one vehicle includes predicting a lane to which the at least one vehicle intends to move based on the driving information of the at least one vehicle.

4. The method of claim 3, wherein the determining the driving information of the at least one vehicle includes:
determining a free space for each lane based on a distance between the other vehicles;
determining a degree by which the other vehicles travel based on the infrastructure information;
determining a speed of each of the other vehicles in a respective lane;
determining a deflection degree based on a center of a lane in which the at least one vehicle drives;
determining an angle at which the at least one vehicle travels with respect to the corresponding lane; and
predicting the lane to which the at least one vehicle intends to move based on at least one of determination results in the determining the free space, the determining the degree, the determining the speed, the determining the deflection degree, or the determining the angle.

5. The method of claim 1, wherein the predicting the first driving path includes predicting the first driving path based on the driving intention and the driving information of the at least one vehicle.

6. The method of claim 1, wherein the determining the target lane of the subject vehicle includes determining the target lane by applying a weight to at least one of a distance between the other vehicles, a traffic flow, or a travel based on infrastructure.

7. The method of claim 1, wherein the determining the second driving path includes:
predicting the first driving path up to a reference time corresponding to a preset prediction maximum time from a current time;
determining a section occupied by the at least one vehicle up to the reference time; and
determining the second driving path not to overlap the section occupied by the at least one vehicle.

8. The method of claim 7, wherein the determining the second driving path includes determining the second driving path and a speed profile of the subject vehicle based on the first driving path of the at least one vehicle predicted for each time up to the reference time from the current time.

9. The method of claim 8, wherein the determining the second driving path of the subject vehicle includes determining any one driving path of lane keeping, lane change, acceleration, and deceleration based on the first driving path of the at least one vehicle predicted for each time up to the reference time from the current time.

10. The method of claim 8, further comprising outputting a control parameter based on the driving path and the speed profile of the subject vehicle.

11. The method of claim 1, further comprising adjusting a warning reference based on the first driving path.

12. A non-transitory computer-readable recording medium having recorded thereon a program for executing the method of claim 1.

13. An apparatus for controlling autonomous driving, the apparatus comprising a controller configured to:
collect driving information of a subject vehicle that autonomously drives and driving information of at least one vehicle among other vehicles around the subject vehicle,
determine a driving environment,
determine driving intention of the at least one vehicle based on the driving information of the at least one vehicle,
predict a first driving path of the at least one vehicle based on the driving intention and the driving information of the at least one vehicle, and
determine a second driving path of the subject vehicle based on the first driving path.

14. The apparatus of claim 13, wherein the driving information includes at least one of information on positions of the subject vehicle and the at least one vehicle, speed information, acceleration information, detailed map information, or infrastructure information including a traffic light, a bus stop, and a school zone.

15. The apparatus of claim 14, wherein the controller is further configured to:
output position information of the subject vehicle using the detailed map information;
output the position information of the subject vehicle and detailed map information of a region around the subject vehicle; and
combine object information including the subject vehicle and the at least one vehicle with the detailed map information and to output combined information.

16. The apparatus of claim 14, wherein the controller is further configured to:
determine a free space for each lane based on a distance between the other vehicles using a determination result of the driving environment;
determine a degree by which the other vehicles travel based on the infrastructure information;
determine a speed of each of the other vehicles in a respective lane;
determine a deflection degree based on a center of a lane in which the at least one vehicle drives;
determine an angle at which the at least one vehicle travels with respect to the corresponding lane; and
predict a lane to which the at least one vehicle intends to drive based on at least one of determination results of the free space, the degree by which the other vehicles travel, the speed of each of the other vehicles, the deflection degree, or the angle at which the at least one vehicle travels.

17. The apparatus of claim 14, wherein the controller is further configured to:
predict the first driving path based on the driving intention and the driving information of the at least one vehicle;
determine a target lane of the subject vehicle based on the first driving path; and
generate the second driving path based on the target lane of the subject vehicle and the first path.

18. The apparatus of claim 17, wherein the controller determines the target lane by applying a weight to at least one of a distance between the other vehicles, a traffic flow, or a travel based on infrastructure.

19. The apparatus of claim 17, wherein the controller predicts the first driving path up to a reference time corresponding to a preset prediction maximum time from a current time, determines a section occupied by the at least one vehicle up to the reference time, and determines the second driving path not to overlap the occupied by the at least one vehicle.
